(19) United States
(12) Patent Application Publication
(10) Pub. No.: US 2018/0013482 A1
(43) Pub. Date: Jan. 11, 2018

(54) METHOD AND UNIT FOR MAPPING INFORMATION BITS TO POLARIZATION ANGLES OF A WAVE

(71) Applicant: Hitachi, Ltd., Tokyo (JP)

(72) Inventor: Ritesh Kumar KALLE, Bangalore (IN)

(21) Appl. No.: 15/637,053

(22) Filed: Jun. 29, 2017

(30) Foreign Application Priority Data
Jul. 8, 2016 (IN) 201641023399

(51) Int. Cl. H04B 7/10

(52) U.S. Cl. CPC H04B 7/10

(57) ABSTRACT

The present disclosure discloses a method and a unit for mapping information bits to polarization angles of a wave for communication. The method comprises transmitting, by a polarization unit of a first communication device, a training signal to a second communication device, for each polarization angle, receiving a feedback signal from the second communication device in response to the training signal, indicating one or more parameters of one or more polarization channels, where each of the one or more polarization channels corresponds to respective polarization angles, categorizing information bits into one or more categories and mapping the information bits to the one or more polarization channels where the mapped information bits are communicated to the second communication device.

### TECHNICAL FIELD

The present disclosure relates in general to communication systems. More particularly, but not exclusively, the present disclosure presents a method and a unit for mapping information bits to polarizing angle of a wave for communication.

BACKGROUND

In any communication system, user aims to achieve minimal data loss while transmitting or receiving data over a communication channel. Various developments are taking place to reduce the data loss. Existing communication systems make use of multiple channels for transmitting data. Such use of multiple channels, reduce data traffic over a single channel. However, data loss still persists due noises, low data gain, incompatible channel capacity, etc.

Technological advancements have been made by generating signals with different polarizing angle. Each polarizing angle of the signal can be used as a different channel for communication. Communicating data over different channels where each channel is associated with a predefined polarizing angle is known in the art. Data can be classified on the basis of its importance as high, medium and low. High importance data should be given priority and relevant priority should be associated with the medium importance data and low importance data respectively. Present day systems transmit high priority data first and low priority data subsequently. However, transmitting high priority data earlier does not assure good channel condition and reliable reception of the high priority data. Further, the existing systems do not analyze different polarization channels suitable for communicating the data. Also, the existing systems do not map the information bits to different polarization angles based on the priority. Therefore, data losses may still occur. Also, important data may not be communicated in time. FIG. 1A shows a diagram illustrating how conventional systems map the data to polarization channels.

### SUMMARY

In an embodiment, the present disclosure discloses a method of mapping information bits to polarization angles of a wave. The method comprises transmitting a training signal by a polarization unit of a first communication device to a second communication device, for each polarization angle. Further, the method comprises receiving a feedback signal from the second communication device in response to the training signal indicating one or more parameters of the one or more polarization channels, categorizing information bits into one or more categories and mapping the information bits to one or more polarization channels for communication.

In an embodiment, the present disclosure presents a polarization unit to transmit a training signal from a first communication device to a second communication device, for each polarization angle, receive a feedback signal from the second communication device in response to the training signal, indicating one or more parameters of one or more polarization channels, categorize information bits into one or more categories and map the information bits to the one or more polarization channels for communicating the information bits to the second communication device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1A shows a diagram illustrating mapping of data to polarization angles by conventional systems;

FIG. 1B shows an exemplary block diagram of a communication system for mapping information bits to polarization angles of a wave in accordance with some embodiments of the present disclosure;

FIG. 2 shows communication device architecture for mapping information bits to polarization angles of a wave in accordance with some embodiments of the present disclosure;

FIG. 3 shows internal architecture of a polarization unit for mapping information bits to polarization angles of a wave in accordance with some embodiments of the present disclosure;

FIG. 4 shows an exemplary flow chart illustrating a method for mapping information bits to polarization angles of a wave in accordance with some embodiments of the present disclosure;

FIG. 5 represents communication sequence diagram illustrating communication between two communication devices in accordance with some embodiments of the present disclosure;

FIG. 6 shows a graph illustrating mapping of information bits to polarization channels in accordance with some embodiments of the present disclosure;

FIG. 7 shows a diagram illustrating an example for mapping information bits to polarization angles in accordance with some embodiments of the present disclosure;

FIG. 8 illustrates queuing of information bits for communicating the information bits over polarization channels;

FIG. 9 shows a flow chart illustrating method steps for classifying information bits in accordance with some embodiments of the present disclosure; and

FIG. 10 shows a computer a block diagram of a general computer system in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure,

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure present a method and a unit for mapping information bits to polarization angle s of a wave for communication. The unit determines one or more parameters of one or more polarization channels using training signals. Further, the unit prioritizes the information bits to be transmitted based on importance. Then, the unit maps the prioritized information bits to one or more polarization channels. Thus, the proposed method helps to reduce data loss. Also, important data is transmitted and received over a relatively good channel.

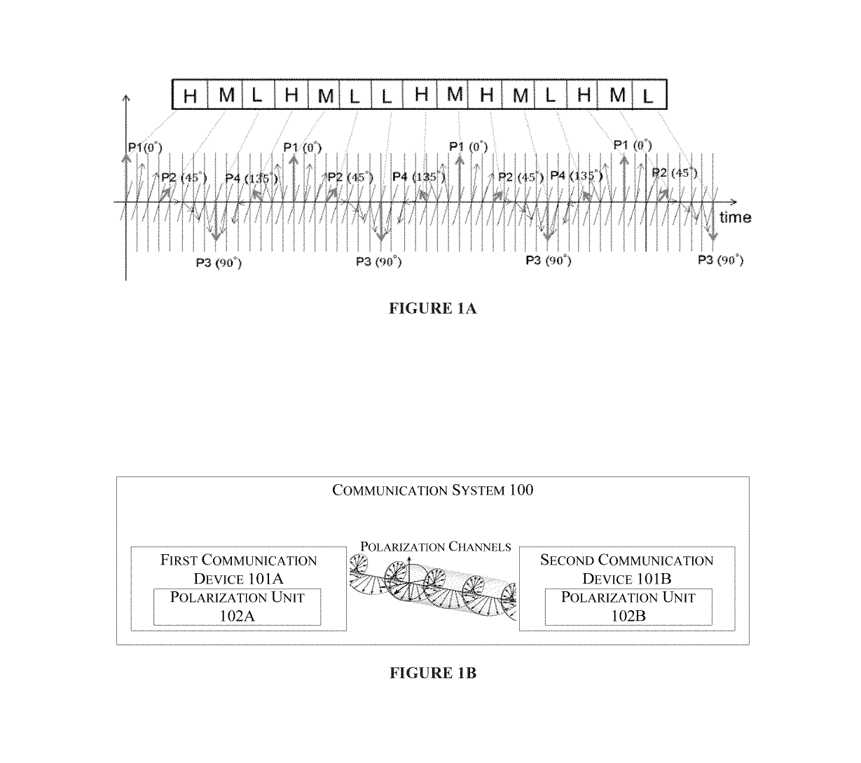

FIG. 1 shows a communication system 100 for mapping information bits to polarization angles of a wave in accordance with some embodiments of the present disclosure. The communication system 100 comprises a first communication device 101A, a second communication device 101B, a polarization unit 102A, a polarization unit 102B and one or more polarization channels for facilitating the communication between the first communication device 101A and the second communication device 101B. Here, the polarization unit 102A resides within the first communication device 101A. Likewise, the polarization unit 102B resides inside the second communication unit 101B. Consider an instance where the first communication device 101A has to communicate information bits to the second communication device 101B over the one or more polarization channels. The polarization unit 102A, of the first communication device 101A maps the information bits to different polarization angles of a wave for communication, based on one or more parameters. Here, each of the different polarization angle acts as an individual polarization channel. Thus the system enables mapping information bits to polarization angles of a wave for successful communication of the information bits.

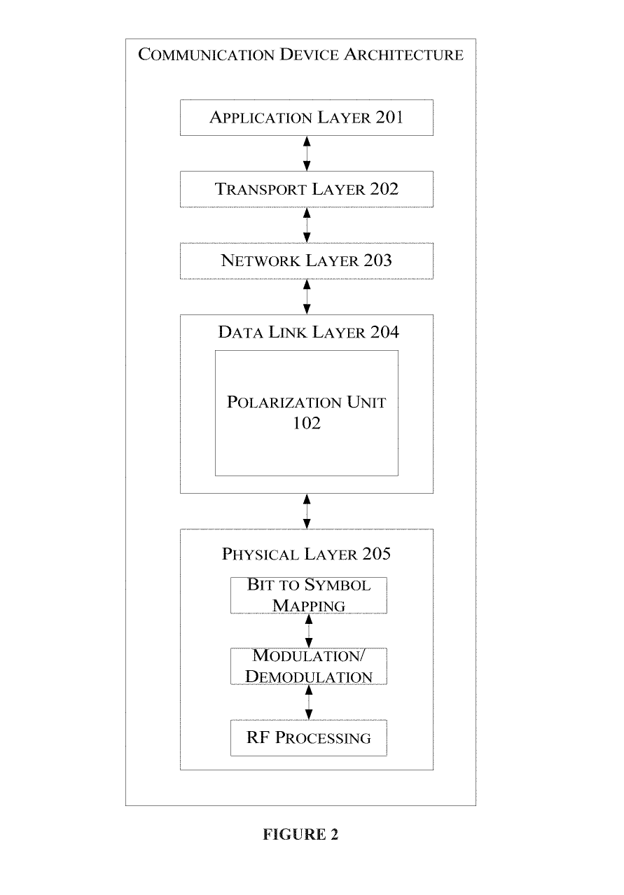

FIG. 2 shows communication device architecture for mapping information bits to polarization angles for communication. The communication device architecture shows various layers through which the information bits traverse for communication. The polarization unit 102A and Polarization unit 102B are configured in data link layer 204 of the communication device architecture.

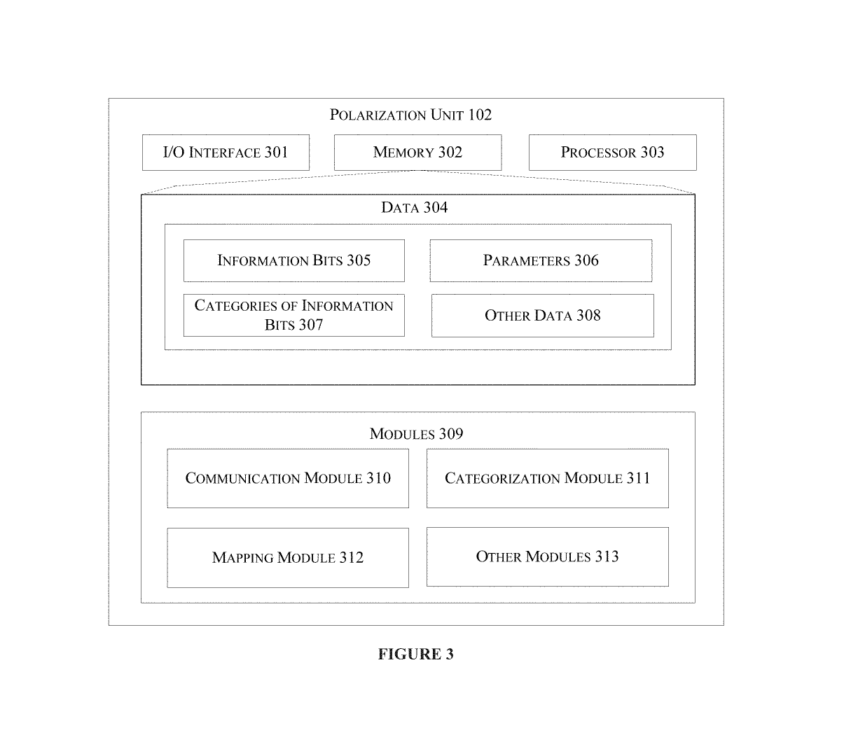

FIG. 3 shows internal architecture of a polarization unit for mapping information hits to polarization angle of a wave for communication.

The polarization unit 102A and polarization unit 102B may include at least one central processing unit (“CPU” or “processor”) 303 and a memory 302 storing instructions executable by the at least one processor 303. The processor 303 may comprise at least one data processor for executing program components for executing user or system-generated requests. A user may include a person, a person using a device such as those included in this disclosure, or such a device itself. The memory 302 is communicatively coupled to the processor 303. In an embodiment, the memory 302 stores one or more data 304. The polarization unit 102A and polarization unit 102B further comprises an Input/Output (I/O) interface 301. The I/O interface 301 is coupled with the processor 303 through which an input signal or/and an output signal is communicated. In an embodiment, the present disclosure describes the invention from perspective of one of the communication devices. For illustration, the present disclosure describes the invention from the first communication device 101A perspective. Hence, hereafter in the present disclosure, polarization unit 102A shall be represented as polarization unit 102.

In an embodiment, one or more data 304 may be stored within the memory 302. The one or more data 304 may include, for example, information bits 305, one or more parameters 306, one or more categories of the information bits 307 and other data 308.

In an embodiment, the information bits 305 may include text, numbers, multimedia, etc. The information bits are digital representation of data. The information bits 305 are transmitted from the first communication device 101A to second communication device 101B.

In an embodiment, the one or more parameters 306 includes at least one of Bit Error Rate (BER), Packet Error rate (PER), Frame Error Rate (FER), Signal to Noise Ratio (SNR), bit energy to noise floor ratio, channel capacity, bit collision data, frequency correction data and phase correction data.

In an embodiment, the one or more categories of the information bits 307 may include high bits, medium bits and low bits. Here, high bits represent information bits with high priority value. Similarly, medium bits represent information bits with medium priority value and low bits represent information bits with low priority value. The present disclosure represents the information bits with high priority value, information bits with medium priority value and information bits with low priority value as high bits, medium bits and low bits respectively hereafter.

The other data 308 may be used to store data, including temporary data and temporary files, generated by modules 309 for performing various functions of the polarization unit 102.

In an embodiment, the one or more data 304 in the memory 302 is processed by modules 309 of the polarization unit 102. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. The said modules when configured with the functionality defined in the present disclosure will result in a novel hardware.

In one implementation, the modules 309 may include, for example, communication module 310, categorization module 311, mapping module 312 and other modules 313. It will be appreciated that such aforementioned modules 309 may be represented as a single module or a combination of different modules.

In an embodiment, the communication module 310 transmits a training signal for each polarization angles of a wave to the second communication device 101B. Further, the communication module 310 receives a feedback signal for each of the polarization angles from the second communication device 101B. The feedback signal indicates the one or more parameters 306 of the one or more polarization channels.

In an embodiment, the categorization module 311 categorizes the information bits 305 into one or more categories 307. The one or more categories 307 may be one of high bits, medium bits and low bits. The categorization is based on importance of the information bits 305. Here, the importance of the information bits 305 is determined by considering at least one of amount of information, criticality of information, etc. Further, the high bits are provided the highest priority for communication.

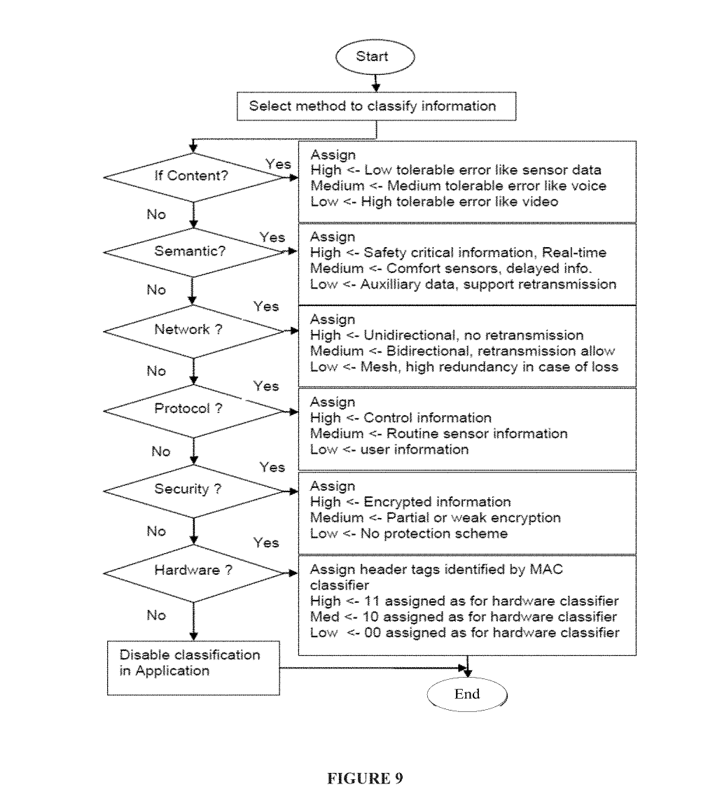

In an embodiment, the mapping module 312 maps the information bits 305 to one or more polarization channels based on the one or more parameters and the categorization. The high bits are mapped to the one or more polarization channels having at least one of BER, PER, FER, SNR and bit collision data less than a corresponding predefined threshold value set for the high bits. The predefined threshold value may be termed as Tolerable Error Rate (TER). Likewise, the medium bits and low bits are communicated over one or more polarization channels having the aforementioned one or more parameters 306 below a predefined threshold value set for the medium bits and low bits respectively. Further, the mapped information bits are communicated to the second communication device 101B. In an embodiment, the information bits 305 are classified based on TER. FIG. 9 shows a flow chart for classifying the information bits 305 based on TER. For example, when security of the information bits 305 is high then the information bits 305 may be categorized at high bits. Similarly when the information bits 305 has medium security then the information bits 305 are categorized at medium hits 305. Likewise, when security of information bits 305 is low, then the information bits 305 are categorized as low bits.

In an embodiment, the other modules 313 may include polarization wave generation module, bit to symbol mapping module, transmission module, etc.

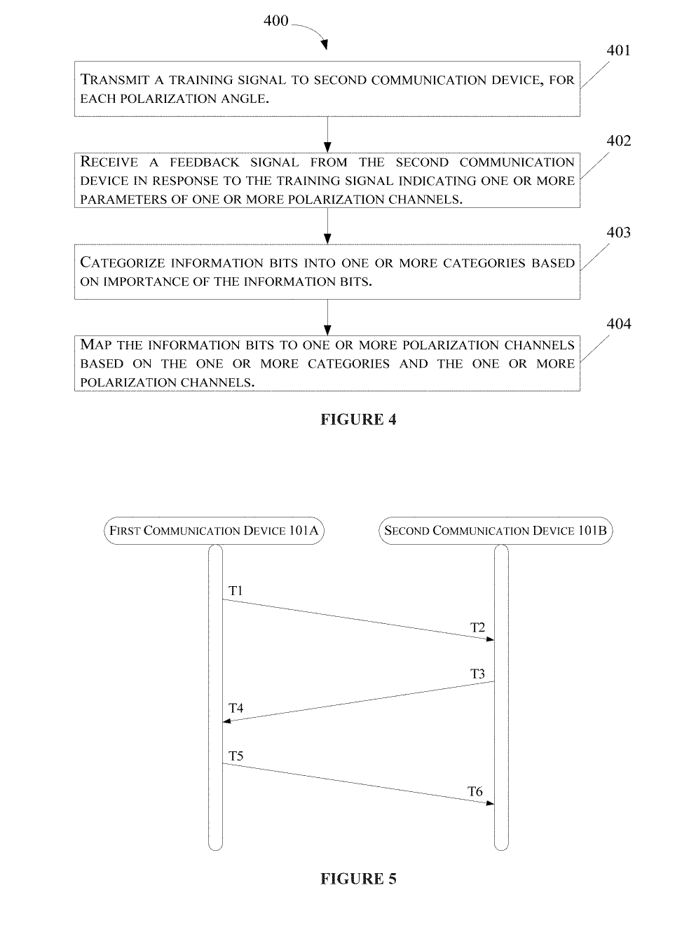

FIG. 4 shows a flowchart illustrating a method of mapping information bits to polarization angle of a wave for communication in accordance with some embodiments of the present disclosure.

As illustrated in FIG. 4, the method 400 may comprise one or more steps for mapping information bits to polarization angles of a wave. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At step 401, transmit a training signal to the second communication device 101B by the communication module 310. Here, the communication module 310 transmits a training signal for each polarization angle to the second communication device 101B. Each of the polarization angles is considered as an independent polarization channel. In an embodiment the polarization angles ranges from 0 degrees to 360 degrees.

At step 402, receive a feedback signal from the second communication device 101B in response to the training signal, by the second communication device 310. The second communication device 310 receives a feedback signal for each of the training signal transmitted for each of the polarization angle.

FIG. 5 shows a sequence diagram illustrating communication between the first communication device 101A and the second communication device 101B. As shown in the figure, at time T1, the first communication device 101A transmits a training signal for each of the polarization angle to the second communication device 101B. The second communication device 101B receives the training signal at T2. Then, the second communication device 101B analyses the training signal and transmits a feedback signal in response to the training signal at time T3. Here, the feedback signal may be communicated over the same channels as the training signal was communicated. Alternatively, the feedback signal can be communicated over different channels. The first communication device 101A receives the feedback signal at time T4. Then, the first communication device 101A processes the feedback signal to determine the one or more parameters 306 of the one or more polarization channels.

Referring back to FIG. 4, at step 403, categorizing information bits 305 into one or more categories 307, by the categorization module 311, based on importance of the information bits 305. Here, the categorization module 311 categorizes the information bits 305 into one of high bits, medium bits or low bits based on the importance of the information bits 305. The high bits are assigned a highest priority for communication with highest accuracy. Likewise medium bits and low bits are provided respective priority. Here, each of the one or more categories 307 is associated with the TER such that, the high bits should have the least TER value, medium bits should have higher TER value relative to high bits and the low bits should have higher TER value relative to high and medium bits. For example, the high bits may have TER value equal to 10⁻⁷; medium bits may have TER value equal to 10⁻⁵; low bits may have TER value equal to 10⁻³.

At step 404, mapping the information bits 305 to one or more polarization channels by the mapping module 312, based on the one or more categories 307 and the one or more parameters 306. The basis of mapping the information bits 305 to the one or more polarization channels is that, values of at least one of the BER, PER, FER and bit collision data of the polarization channel should be below the TER values of respective categories. Here, based on the above said basis, the one or more channels are identified by the mapping module 313 for mapping the information bits 305.

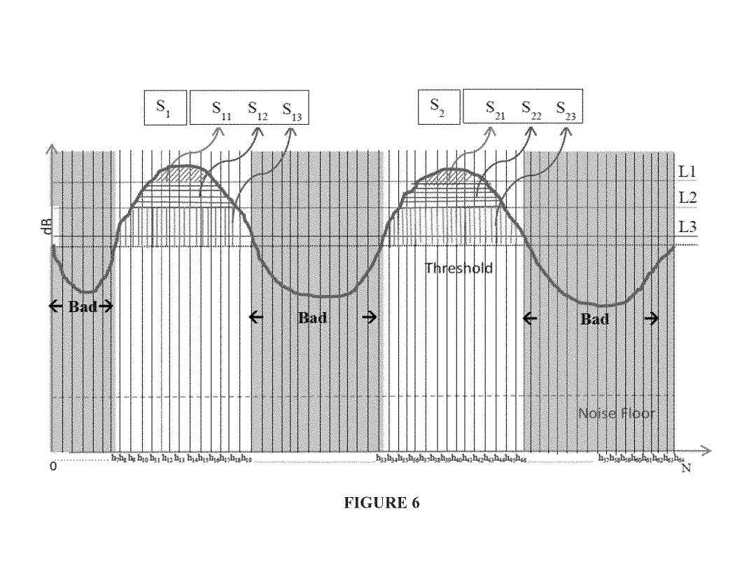

FIG. 6 shows a graph illustrating mapping of the information bits 305 to one or more polarization channels based on the one or more parameters 306 and the one or more categories 307. For illustration, FIG. 6 shows mapping of the information bits 305 to the one or more polarization channels based on channel gain. The graph illustrates that, the high bits are mapped to the one or more polarization channels having highest channel gain among the one or more polarization channels.

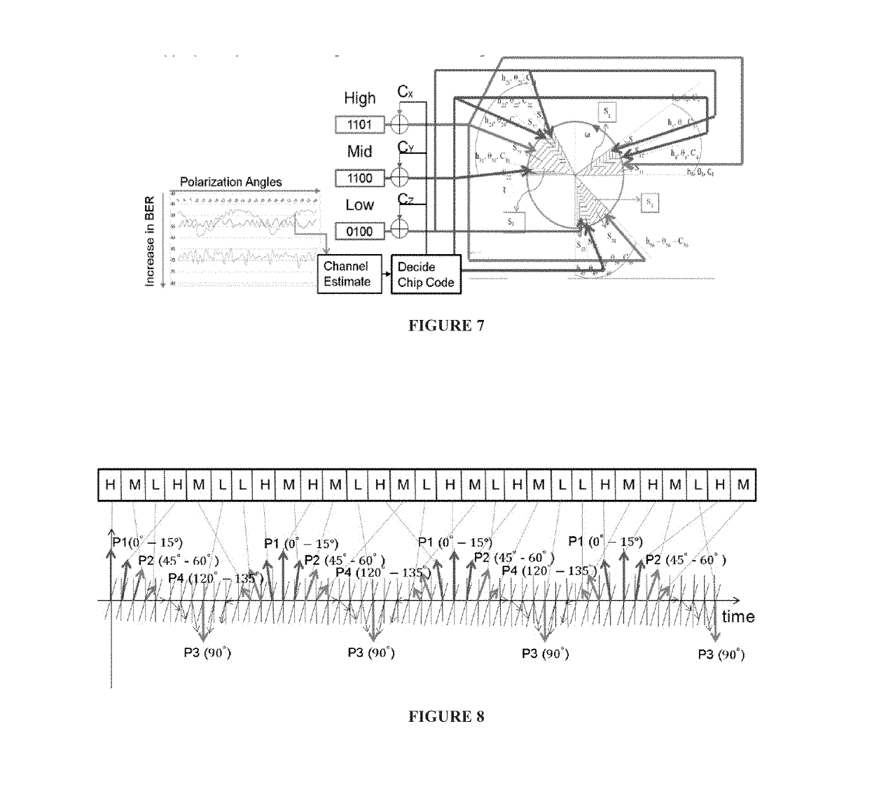

In an embodiment, the information bits 305 which are mapped to the one or more polarization channels are then encoded with symbols. The bit to symbol mapping is performed in physical layer 205 of the network architecture. Here, the bit to symbol mapping is performed for assigning the information bits 305 to corresponding one or more polarization channels, thereafter transmitting the information bits 305 over the corresponding one or more polarization channels. Here, the bit to symbol mapping is done by assigning each information bit 305 with a unique chip sequence. The unique chip sequence may comprise information about the polarization angle of the wave. The chip sequence helps identify the corresponding one or more polarization channels. FIG. 7 shows a diagram illustrating an example for mapping of the information bits 305 to corresponding one or more polarization channels. Also, mapping the information bits to symbols by using chip sequence is represented in the FIG. 7.

In an embodiment, the information bits 305 which are mapped to the one or more polarization channels are stored in one or more queues for transmitting to the second communication device 101. As described above, the information bits 305 are encoded with unique chip sequence for assigning the information bits 305 to the respective one or more polarization channels. Hence, the information bits 305 are stored in one or more queues until the corresponding polarization channel is identified. FIG. 8 illustrates the queuing of the information bits 305. As shown in the figure, consider P1 as the first polarization channel. Let the polarization angle range from 0°-15°. Let P2 represent second polarization channel and let the range vary from 45°-60°. Likewise, let P3 be the third polarization channel and the angle associated be 90°. Let the polarization unit 102 consider P1 suitable for high bits, P2 suitable for medium bits and P3 suitable for low bits. Here, the mapping is completed and the information bits 305 are yet to be assigned to the corresponding polarization channel. Each of the high bits may be stored in one or more queues. Likewise, the medium bits and the low hits may be stored in corresponding one or more queues. When a wave is generated, until P1 is identified, each of the high bits is stored in the corresponding one or more queues. When P1 is identified, at least one high bit is assigned to P1 for transmitting to the second communication device 101B. Similarly, when P2 is identified, at least one medium bit is assigned to P2 for communicating to the second communication device 101B.

In an embodiment, the medium and low bits may be assigned to one or more polarization channels corresponding to high bits based on the channel capacity of the one or more polarization channels corresponding to the high bits. Similarly, low bits may be assigned to the one or more polarization channels corresponding to the medium bits based on channel capacity.

In an embodiment, polarization unit 102 determines channel capacity for each of the one or more polarization channels corresponding to respective one or more categories 307. The determination is performed prior to transmission of every bit of the information bits 305. Thereafter, the information bits 305 are assigned to respective one or more polarization channels based on the channel capacity.

Referring back to FIG. 5, the communication device 101A transmits the information bits 305 to the second communication device 101B at time T5. At T6, the second communication device 101B receives the information bits 305.

In an embodiment, the TER is determined based on at least one of content of the information bits, semantics of the information bits, network over which the information bits are communicated, communication protocol followed by the information bits and encryption of the information bits.

In an embodiment, the content of the information bits comprises text data, voice data, multimedia data, etc. The semantic data may comprise nature of information sources such as safety, comfort, urgency of correct information, etc. The network data may comprise directional information of data bits, mesh information, etc. The protocol information may comprise type of protocols used for communication, etc. The encryption data may comprise encryption standards used to encode the information bits 305.

In an embodiment, the polarization unit 102 can communicate the information bits 305 to plurality of communication devices. Here, the polarization unit 102 of the first communication device 101A can transmit information bits 305 to the plurality of communication devices over one or more polarization channels. Here, the polarization unit 102 transmits a training signal for each polarization angle to each of the plurality of communication devices. Further, the first communication device 101A receives a feedback signal in response to the training signal from each of the plurality of communication devices. Upon determining one or more parameters 306 of the one or more polarization channels, the polarization unit 102 maps the information bits 305 to corresponding one or more polarization channels of corresponding plurality of communication devices.

### Computer System

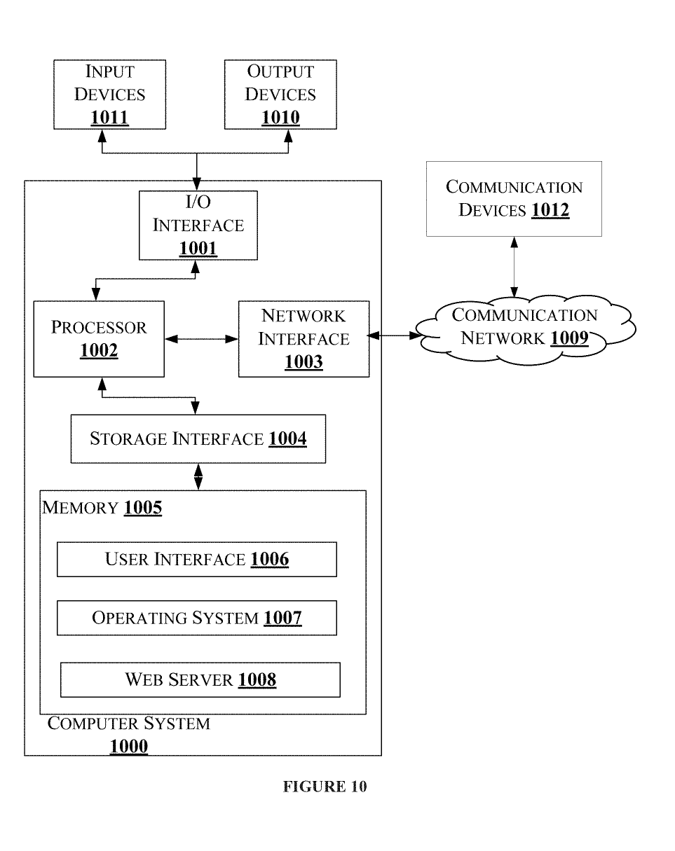

FIG. 10 illustrates a block diagram of an exemplary computer system 1000 for implementing embodiments consistent with the present disclosure. In an embodiment, the computer system 1000 is used to implement the method of mapping information bits to polarization angles of a wave. The computer system 1000 may comprise a central processing unit (“CPU” or “processor”) 1002. The processor 1002 may comprise at least one data processor for executing program components for dynamic resource allocation at run time. The processor 1002 may include specialized processing units such as integrated system (bus) controllers, memory management control units, floating point units, graphics processing units, digital signal processing units, etc.

The processor 1002 may be disposed in communication with one or more input/output (I/O) devices (not shown) via I/O interface 1001. The I/O interface 1001 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e,g., code-division multiple access (CDMA), high-speed packet access (HSPA+), global system for mobile communications (GSM), long-term evolution (LTE), WiMax, or the like), etc.

Using the I/O interface 901, the computer system 1000 may communicate with one or more I/O devices. For example, the input device 1011 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 1012 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 1000 is connected to the service operator through a communication network 1009. The processor 1002 may be disposed in communication with the communication network 909 via a network interface 1003. The network interface 1003 may communicate with the communication network 1009. The network interface 1003 may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network 1009 may include, without limitation, a direct interconnection, e-commerce network, a peer to peer (P2P) network, local area network (LAN), wide area network (WAN), wireless network (e.g., using Wireless Application Protocol), the Internet, etc. Using the network interface 1003 and the communication network 1009, the computer system 1000 may communicate with the one or more service operators.

In some embodiments, the processor 1002 may he disposed in communication with a memory 1005 (e.g., RAM, ROM, etc. not shown in FIG. 10) via a storage interface 1004. The storage interface 1004 may connect to memory 1005 including, without limitation, memory drives, removable disc drives, etc., employing connection protocols such as serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 1005 may store a collection of program or database components, including, without limitation, user interface 1006, an operating system 1007, web server 1008 etc. In some embodiments, computer system 1000 may store user/application data 1006, such as the data, variables, records, etc. as described in this disclosure. Such databases may be implemented as fault-tolerant, relational, scalable, secure databases such as Oracle or Sybase.

The operating system 1007 may facilitate resource management and operation of the computer system 1000. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, 10 etc.), Apple iOS, Google Android, Blackberry OS, or the like.

In some embodiments, the computer system 1000 may implement a web browser 1007 stored program component. The web browser 1008 may he a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers 1008 may utilize facilities such as AJAX, DHTML, Adobe Flash, JavaScript, Java, Application Programming Interfaces (APIs), etc. In some embodiments, the computer system 1000 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 1000 may implement a mail client stored program component. The mail client may be a mail viewing application, such as Apple Mail, Microsoft Entourage, Microsoft Outlook, Mozilla Thunderbird, etc. In an embodiment, the computer system 1000 may be connected to communication devices 1012 over the communication network 1009.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

In an embodiment, the method as disclosed, maps the information bits to corresponding polarization channels based on one or more channel parameters. Hence, proposed method can provide differential error protection by mapping priority bits to efficient polarization channels.

In an embodiment, the method increases throughput of the system by ensuring communication over efficient polarization channels.

In an embodiment, the method communicates the bits based on channel capacity. Thus, channel bandwidth is reduces substantially.

Information loss is reduced as multiple channels are utilized. Also, the high priority bits are communicated over dedicated polarization channels. Further, medium bits and low bits are not communicated over channels dedicated for high bits. Thus, the proposed method ensures communication of delicate data with minimum data loss.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

REFERRAL NUMERALS:

| Reference | |
|---|---|
| number | Description |
| 100 | Communication system |
| 101A | First communication device |
| 101B | Second communication device |
| 102 | Polarization unit |
| 201 | Application layer |
| 202 | Transport layer |
| 203 | Network layer |
| 204 | Data link layer |
| 205 | Physical layer |
| 301 | I/O interface |
| 302 | Memory |
| 303 | Processor |
| 304 | Data |
| 305 | Information bits |
| 306 | Parameters |
| 307 | Categories of information bits |
| 308 | Other data |
| 309 | Modules |
| 310 | Communication module |
| 311 | Categorization module |
| 312 | Mapping module |
| 313 | Other module |
| 1000 | General computer system |
| 1001 | I/O Interface |
| 1002 | Processor |
| 1003 | Network Interface |
| 1004 | Storage Interface |
| 1005 | Memory |
| 1006 | User Interface |
| 1007 | Operating System |
| 1008 | Web Server |
| 1009 | Communication Network |
| 1010 | Output device |
| 1011 | Input Device |
| 1012 | Communication devices |

We claim:

1. A method of mapping information bits to polarization angles of a wave for communication, comprising:
transmitting, by a polarization unit of a first communication device, a training signal to a second communication device, for each polarization angle;
receiving, by the polarization unit, a feedback signal from the second communication device in response to the training signal, indicating one or more parameters of one or more polarization channels, wherein each of the one or more polarization channels corresponds to respective polarization angles;
categorizing, by the polarization unit, information bits into one or more categories based on importance of the information bits; and
mapping, by the polarization unit, the information bits to the one or more polarization channels based on the one or more categories and the one or more parameters, wherein the mapped information bits are communicated to the second communication device.

2. The method as claimed in claim 1, wherein the information bits are categorized into one or more categories based on at least one of content of the information bits, semantics of the information bits, network over which the information bits are communicated, communication protocol followed by the information bits and encryption of the information bits.

3. The method as claimed in claim 1, wherein the one or more categories of the information bits are one of high bits, medium bits and low bits.

4. The method as claimed in claim 1, wherein the one or more parameters comprises at least one of Bit Error Rate (BER), Packet Error rate (PER), Frame Error Rate (FER), Signal to Noise Ratio (SNR), bit energy to noise floor ratio, channel capacity, bit collision data, frequency correction data and phase correction data.

5. The method as claimed in claim 1, wherein the categorized information bits are mapped to the one or more polarization channels when values of at least one of the BER, PER, FER and bit collision data of the polarization channel are below a predefined threshold value of respective one or more categories.

6. The method as claimed in claim 1, wherein the information bits which are mapped, are stored in one or more queues for communicating to the second communication device.

7. A polarization unit for mapping information bits to polarization angles of a wave for communication, comprising:
a processor; and
a memory, communicatively coupled to the processor, to store processor executable instructions, which, on execution, causes the processor to:
transmit a training signal to a second communication device, for each polarization angle;
receive a feedback signal from the second communication device in response to the training signal, indicating one or more parameters of one or more polarization channels, wherein each of the one or more polarization channels corresponds to respective polarization angles;
categorize information bits into one or more categories based on importance of the information bits; and
map the information bits to the one or more polarization channels based on the one or more categories and the one or more parameters, wherein the mapped information bits are communicated to the second communication device.

8. The polarization unit as claimed in claim 7, wherein the information bits are categorized into one or more categories based on at least one of content of the information bits, semantics of the information bits, network over which the information bits are communicated, communication protocol followed by the information bits and encryption of the information bits.

9. The polarization unit as claimed in claim 7, wherein the one or more categories of the information bits are one of high bits, medium bits and low bits.

10. The polarization unit as claimed in claim 7, wherein the one or more parameters comprises at least one of Bit Error Rate (BER), Packet Error rate (PER), Frame Error Rate (FER), Signal to Noise Ratio (SNR), bit energy to noise floor ratio, channel capacity, bit collision data, frequency correction data and phase correction data.

11. The polarization unit as claimed in claim 7, wherein the categorized information bits are mapped to the one or more polarization channels when values of at least one of the BER, PER, FER and bit collision data of the polarization channel is below a predefined threshold value of respective one or more categories.

12. The polarization unit as claimed in claim 7, wherein the information bits which are mapped, are stored in one or more queues for communicating to the second communication device.
